(19) United States
(12) Patent Application Publication
(10) Pub. No.: US 2012/0211630 A1
(43) Pub. Date: Aug. 23, 2012

(54) THREE-DIMENSIONAL OBLIQUE MICROSTRUCTURE WITH PRESS DOWN AND ENGAGEMENT MECHANISMS

(76) Inventors: Yi Chiu, Hsinchu (TW); Hsi-Fu Shih, Hsinchu (TW); Chen-An Lin, Hsinchu (TW)

(21) Appl. No.: 13/402,640

(22) Filed: Feb. 22, 2012

(30) Foreign Application Priority Data
Feb. 23, 2011 (TW) 100105920

(51) Int. Cl. F16M 13/00

(52) U.S. Cl. 248/346.04

(57) ABSTRACT

A three-dimensional oblique microstructure with press down and engagement mechanisms. A pair of corresponding first lugs is disposed on the both sides of the oblique body, and the bottom part of the oblique body has a first push pad. A pair of corresponding second lugs respectively disposed on the inner sides of the two supports of the α-shaped supporting rack, a second push pad is disposed on the bottom part of the U-shaped supporting rack. Thus, by pressing down the first and the second push pad, the oblique body rotates through the first twist bar and the U-shaped supporting rack rotates through the second twist bar so as to engage the first lugs with the second lugs, such that the three-dimensional microstructures with different angles can be packed to satisfy the needs of varied optical platform applications, and simplify semiconductor fabrication for higher production efficiency and product yield.

### CROSS-REFERENCE TO RELATED APPLICATION

This application claims the benefit of Taiwan Patent Application No. 100105920, filed on Feb. 23, 2011, which is hereby incorporated by reference for all purposes as if fully set forth herein.

### BACKGROUND OF THE INVENTION

1. Field of the Invention

The present invention is related to a packing structure, especially to a three-dimensional oblique microstructure with press down and engagement mechanisms, which can pack any three-dimensional oblique microstructure with different erected angles.

2. Description of Related Art

Recently, with the development of semiconductor technology, the technology of Microelectromechanical System (MEMS) has a lot of major breakthrough. For the optical system, Micro Optical Electro Mechanical System is the good solution for providing fabrication of more compact and lighter micro optical system.

A three-dimensional oblique microstructure has many applications in MEMS, such as mirror and plane optical device in micro optical system, and coil inductance in radio frequency application. Most of these devices are made on a film by surface micromachining technology, and then these devices are erected to form a three-dimensional micro system.

There are many conventional technologies can be used to pack the three-dimensional device, wherein a micro hinge is a common way to secure the erecting device. Except for using probes to pack manually, the ways of pack by external forces include magnetic force, electrostatic force, centrifugal force, ultrasound vibration and micro actuator. Besides, the self-assembling includes using pre-stressed bimorph beams and surface tension. Since system packaging requires to connect and wire a plurality of chips, and an automatic packaging can be performed by using the standard equipment of the electronic packaging process or special equipment. In addition, by using a function of pick-and-place in the standard equipment and wiring equipment to assist the assembling of MEMS devices may achieve a more reliable, flexible, and systematic assembling and packaging process.

However, one of the major difficulties for assembling the three-dimensional microelectromechanical system (MEMS) by using the standard equipment of the electronic packaging process is controlling and locating a probe or a harp picker. That is, because a gap between the erecting device and a substrate is very small, the action of inserting the probe into the gap requires more degrees of freedom and high precision control. Moreover, in addition to the angle error problem of the structure generated by using a micro hinge as a securing erecting, the design of the micro hinge still cannot be simplified in semiconductor fabrication, such that the production efficiency and product yield are both low.

### SUMMARY OF THE INVENTION

In order to solve the shortcomings described above, an objective of the present invention is to provide a three-dimensional oblique microstructure with press down and engagement mechanisms. Through the rotation and engagement and the positions of the lugs, the oblique body can secured with the U-shaped supporting rack, such that any three-dimensional microstructure with different angles can be packed by the three-dimensional oblique microstructure of the present invention through the press down and engagement mechanisms for varied optical platform applications.

Another objective of the present invention is to provide a three-dimensional oblique microstructure with press down and engagement mechanisms. By press down and engagement mechanisms, the oblique body can secure with the U-shaped supporting rack. In addition, the three-dimensional oblique microstructure can be fabricated through the simplified semiconductor process to have high production efficiency and product yield.

For the objectives described above, the three-dimensional oblique microstructure with press down and engagement mechanisms includes a substrate; an oblique body disposed on the substrate and having a pair of corresponding first lugs respectively on both sides of the oblique body, a bottom part of the oblique body having a first push pad and a first accommodation space disposed in the substrate for receiving the first push pad, and a first twist bar extending horizontally from both sides disposed on the bottom part of the oblique body; and an U-shaped supporting rack disposed on the substrate, a pair of corresponding second lugs respectively disposed on inner sides of two supports of the U-shaped supporting rack, a second push pad disposed on a bottom part of the U-shaped supporting rack, a second accommodation space disposed in the substrate for receiving the second push pad, and a second twist bar extending horizontally from both sides disposed on the bottom part of the U-shaped supporting rack; by pressing down the first push pad and the second push pad, the oblique body rotating to an angle through the first twist bar as an axle center and the U-shaped supporting rack rotating to an angle through the second twist bar as an axle center so as to form the three-dimensional microstructure by engaging the first lugs with the second lugs.

Wherein the first push pad of the oblique body and the second push pad of the U-shaped supporting rack are formed in opposite directions, and the shape of an upper part of the oblique body is matched with the shape of the bottom part of the U-shaped supporting rack. Or, the first push pad of the oblique body and the second push pad of the U-shaped supporting rack are formed in a same direction, and the shape of the first push pad of the oblique body is matched with the shape of the bottom part of the U-shaped supporting rack. wherein positions of the first lugs on the both sides of the oblique body is arranged by a predetermined oblique angle and correspond to positions of the second lugs of the U-shaped supporting rack so as to engage each other for securing the oblique body and the U-shaped supporting rack. and the positions of the second lugs on the inner sides of the supports of the U-shaped supporting rack is arranged by a predetermined oblique angle of the oblique body and correspond to the first lugs of the oblique body so as to engage each other for securing the oblique body and the U-shaped supporting rack.

The advantage of the present invention is applicable to a plurality of microstructures in a form of array. Each microstructure includes an oblique body and a U-shaped supporting rack. By using automatic control probes to press down the push pads, the oblique body can secured with the U-shaped supporting rack. In addition, through adjusting the positions of lugs, the three-dimensional microstructure with different angles can easily be packed by the three-dimensional oblique microstructure of the present invention so as to fit the needs of the varied optical platform applications. Besides, the semiconductor fabrication is much simplified and the production efficiency and product yield are high.

### BRIEF DESCRIPTION OF THE DRAWINGS

FIG. 1 shows a three-dimension view of a three-dimensional oblique microstructure according to one embodiment of the present invention.

FIG. 2 shows a plane view of the three-dimensional oblique microstructure before packing according to one embodiment of the present invention.

FIG. 3A to 3D shows the packing of the microstructure according to one embodiment of the present invention.

FIG. 4 is a schematic diagram illustrating the configuration of a three-dimensional microstructure with an angle 45°.

FIG. 5 is a schematic diagram illustrating the configuration of a three-dimensional microstructure with an angle 60°.

FIG. 6 is a schematic diagram illustrating the configuration of a three-dimensional microstructure with an angle 30°.

FIG. 7 is a plane schematic diagram before packing according to another embodiment.

FIG. 8 is a schematic diagram illustrating the configuration of a three-dimensional microstructure with an angle 135°.

FIG. 9A to 9F are the schematic diagrams illustrating packing according to the embodiment shown in FIG. 7.

FIG. 10 is a schematic diagram 1 illustrating the accommodation space according to another embodiment of the invention.

FIG. 11 is a schematic diagram 2 illustrating the accommodation space according to still another embodiment of the invention.

FIG. 12 is a schematic diagram 3 illustrating the accommodation space according to still another embodiment of the invention.

### DETAILED DESCRIPTION

Detail of the content and description of the technology related to the present invention are described according to the embodiments. It should be understood that these embodiments only describe the examples and are not limited to the embodiments of the present invention.

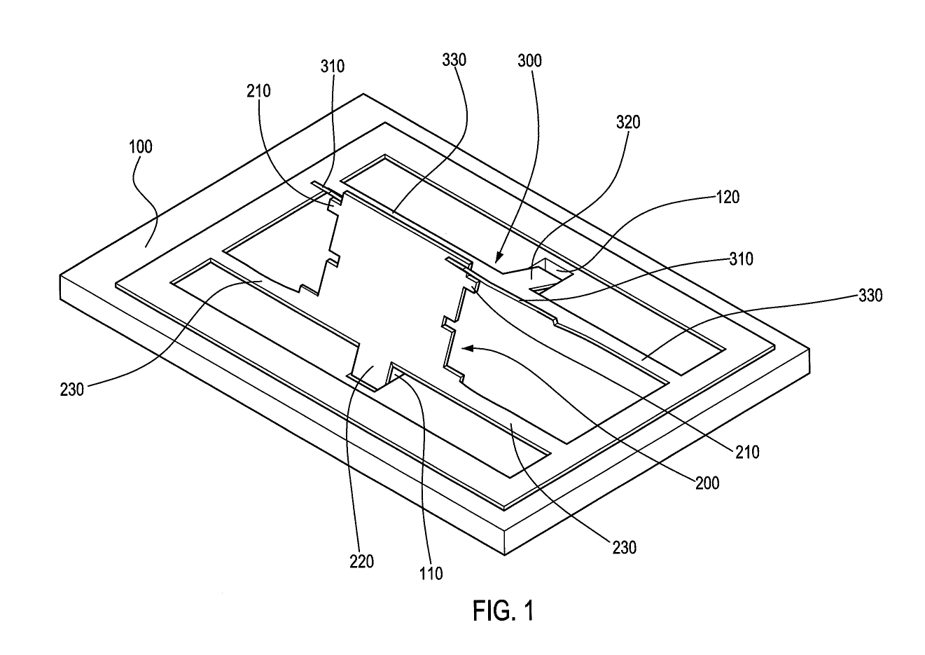

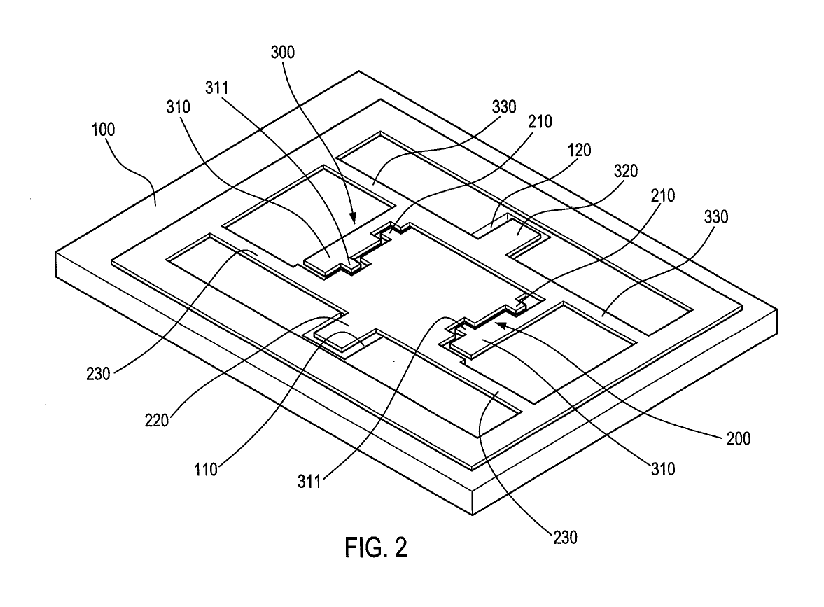

FIGS. 1 and 2, respectively, show a three-dimension view of a three-dimensional oblique microstructure and a plane view of the three-dimensional oblique microstructure before packing according to one embodiment of the present invention. In one embodiment, a micro-mirror plate may be made by a silicon on insulator (SOI) substrate with almost zero tension and thicker structure to avoid wrapping problems by using polycrystalline silicon in manufacturing processes. The three-dimensional oblique microstructure includes a substrate 100, and an oblique body 200 disposed on the substrate 100.

Two sides of the oblique body 200 are respectively disposed with a first lug 210 that correspond to each other. A first push pad 220 is disposed on the bottom part of the oblique body 200, and a first accommodation space 110 is located in the substrate 100 for receiving the bottom part of the first push pad 220. In addition, a first twist bar 230 extending horizontally from both sides is disposed on the bottom part of the oblique body 200. According to one embodiment the oblique body 200 may be a micro-mirror plate, whose surface may be a reflective mirror plate. This embodiment of the microstructure may apply to a micro-optical data storage system, an optical switch of the fiber optic communication, and a display etc, as well as apply to the micro lens in displays, or coil inductance in radio frequency application.

Also, a U-shaped supporting rack 300 is disposed on the substrate 100, and the inner sides of two supports 310 of the U-shaped supporting rack 300 are respectively disposed with a second lugs 311 that correspond to each other. A second push pad 320 is disposed on the bottom part of the U-shaped supporting rack 300, and a second accommodation space 120 is located in the substrate 100 for receiving the bottom part of the second push pad 320. In addition, a second twist bar 330 extending horizontally from both sides is disposed on the bottom part of the U-shaped supporting rack 300.

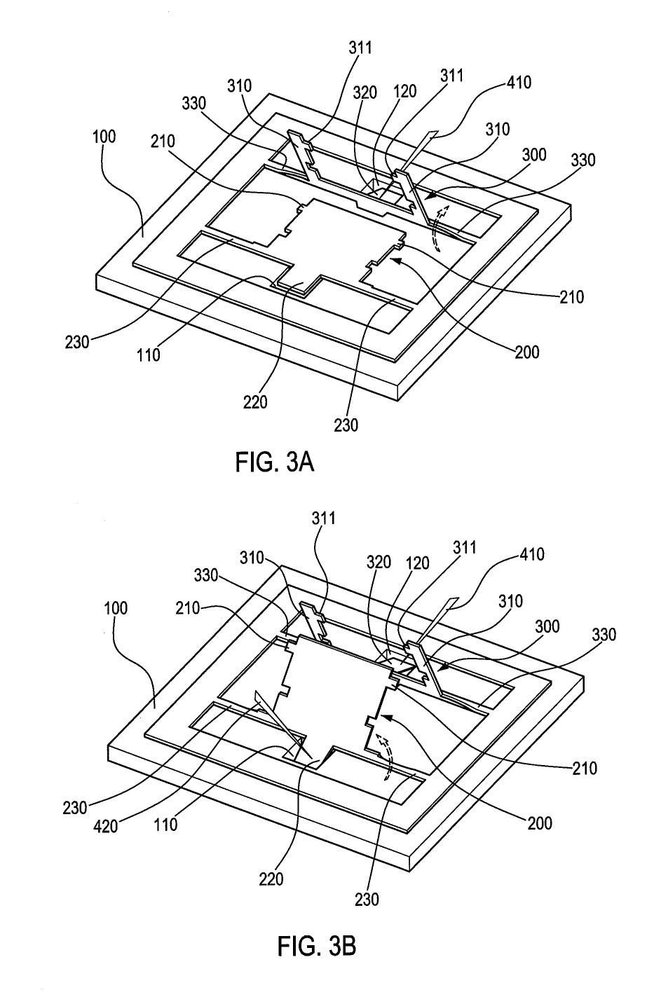

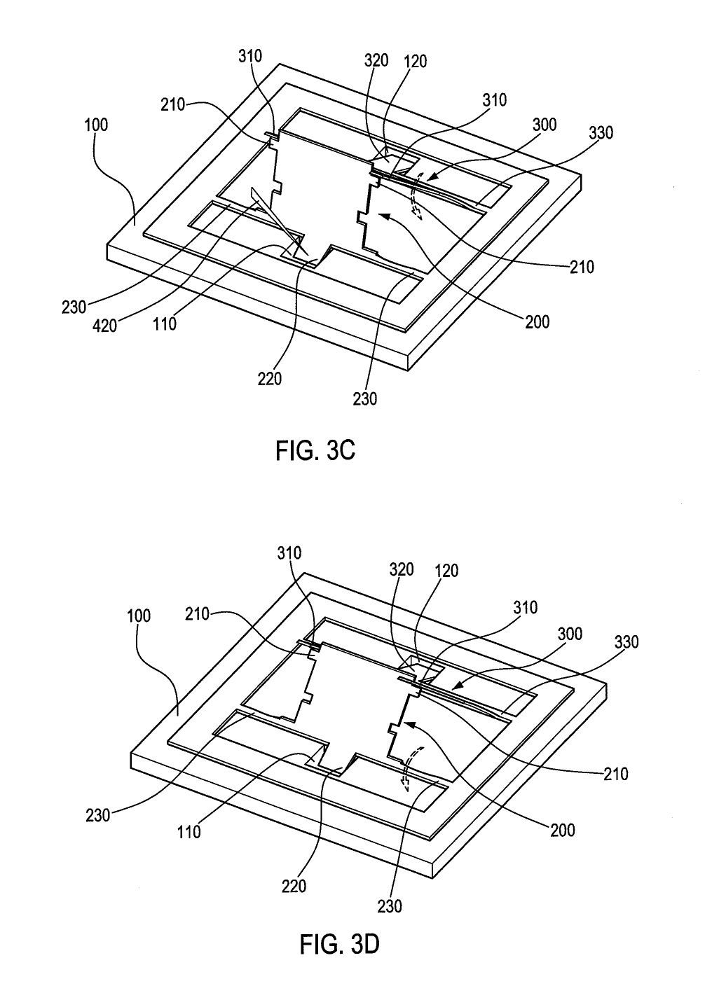

Please refer to FIG. 3A to 3D, the diagrams show the packing of the microstructure according to one embodiment of the present invention. During the packing process, a first probe 410 is used to press down the second push pad 320 into the second accommodation space 120 to make the U-shaped supporting rack 300 rotate upward to an angle through the second twist bar 330 as an axle center (as shown in FIG. 3A); then a second probe 420 is used to press down the first push pad 220 into the first accommodation space 110 to make the oblique body 200 rotate upward to an angle through the first twist bar 230 as axle center (as shown in FIG. 3B); the first probe 410 is released to make the two supports 310 of the U-shaped supporting rack 300 press on the sides of the first lugs on both sides of the oblique body 200 by the restoring force of the second twist bar 330 (as shown in FIG. 3C); finally, the second probe 420 is released, and the restoring force of the first twist bar 230 make the oblique body 200 press down (as shown in FIG. 3D). Therefore, the first lugs 210 of the oblique body 200 and the second lugs 311 of the supports 310 of the U-shaped supporting rack 300 may be engaged with each other for securing the oblique body 200 and the U-shaped supporting rack 300.

In practice, the oblique body 200 and the U-shaped supporting rack 300 may be made on the surface of the substrate 100 by conventional semiconductor technologies. For example, the oblique body 200 and the U-shaped supporting rack 300 may be formed on the silicon layer of the SOI substrate. Then, the silicon (Si) layer is patternized by photolithography process. The positions of the first lugs on the oblique body 200 are arranged according to a predetermined oblique angle, and the positions of the first lugs 210 correspond to that of the second lugs 311 of the U-shaped supporting rack 300 so as to engage each other for securing the oblique body 200 and the U-shaped supporting rack 300. In detail, the positions of the inner sides of the second lug 311 of the supports 310 correspond to the first lugs 210 of the oblique body 200 according to the predetermined oblique angle.

From the process described above, the first twist bar 230 of the oblique body 200 and the second twist bar 330 of the U-shaped supporting rack 300 are disposed corresponding to the first lugs 210 of the oblique body 200 and the second lugs 311 of the U-shaped supporting rack 300 so as to define the oblique angle of the oblique body 200. In practice, through the adjustment of the layout of the semiconductor fabrication, if under the situation that of the relative positions of the first twist bar 230 of the oblique body 200 and the second twist bar 330 of the U-shaped supporting rack 300 are fixed, when the oblique angle of the oblique body 200 is not greater than 90°, the first push pad 220 of the oblique body 200 and the second push pad 320 of the U-shaped supporting rack 300 are formed in opposite directions. In addition, the length of two supports 310 of the U-shaped supporting rack and the positions of the second lug 311 defined by an etching process, as well as the positions of the first lug 210 on the both sides of the oblique body 200, thus the three-dimensional microstructure with various angles not greater than 90° may be packed to fit the optical platform applications.

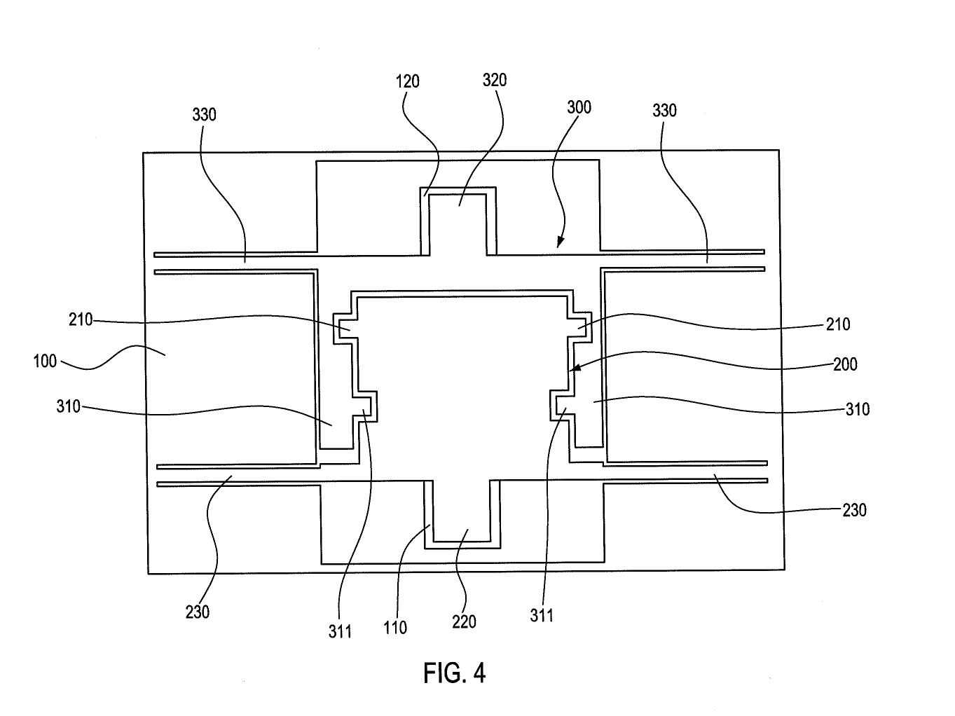

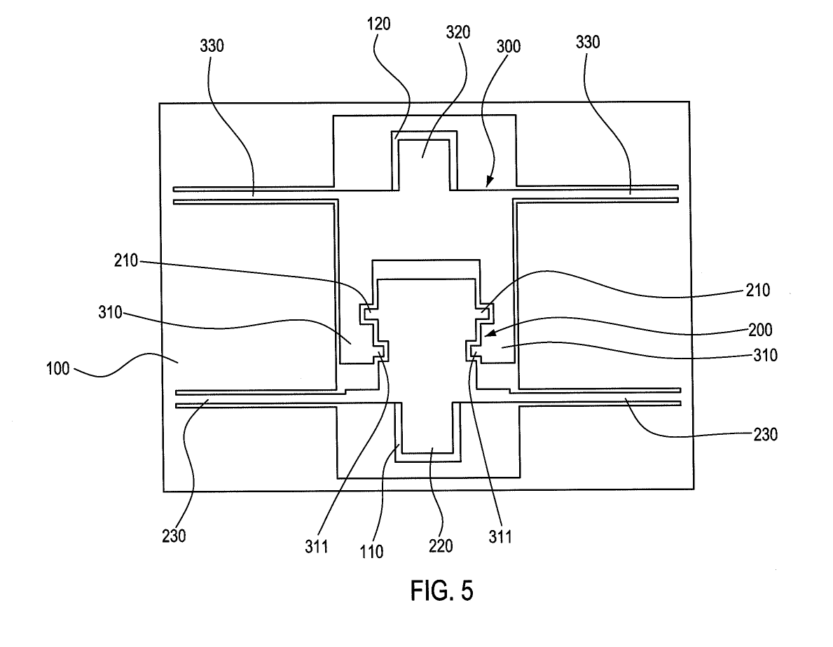

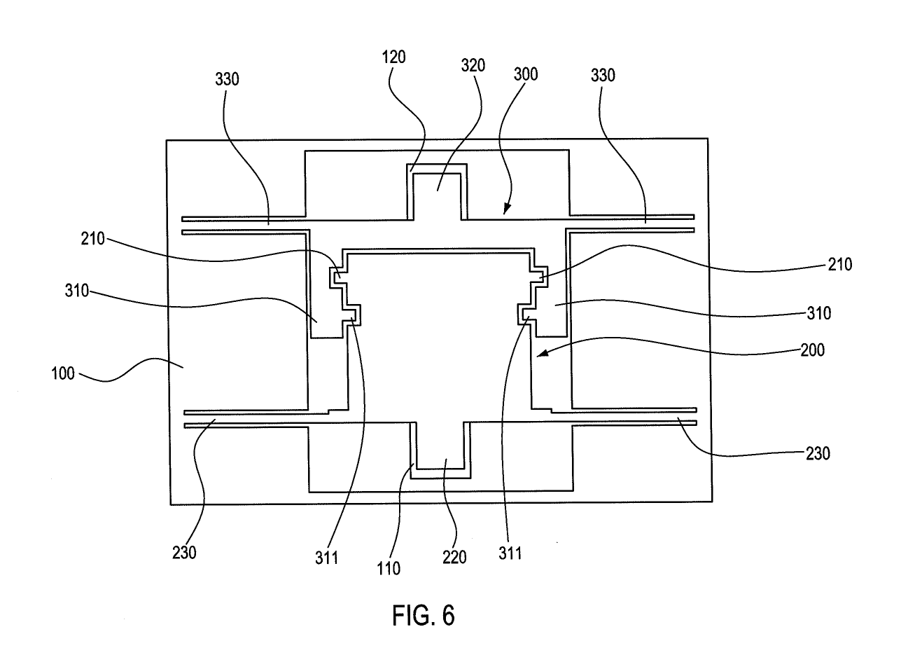

For example, when the height of the oblique body 200 is equal to the length of the support 310 (as shown in FIG. 4), the microstructure of the present invention can be used to pack the three-dimensional oblique microstructure with an angle equal to 45°. When the height of the oblique body 200 is shorter than the length of the support 310 (as shown in FIG. 5), the microstructure of the present invention can be used to pack the three-dimensional oblique microstructure with an angle greater than 45°, such as FIG. 5 which shows the configuration of the three-dimensional oblique microstructure with an angle 60°. When the height of the oblique body 200 is longer than the length of the support 310 (as shown in FIG. 6), the microstructure of the present invention can be used to pack the three-dimensional oblique microstructure with an angle smaller than 45°, such as FIG. 6 which shows the configuration of the three-dimensional oblique microstructure with an angle 30°.

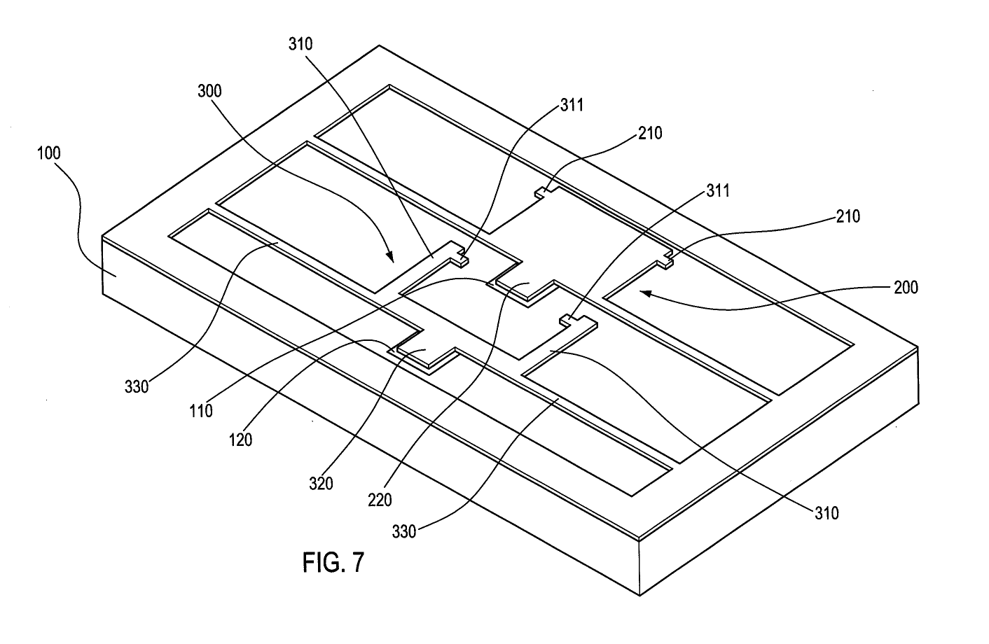

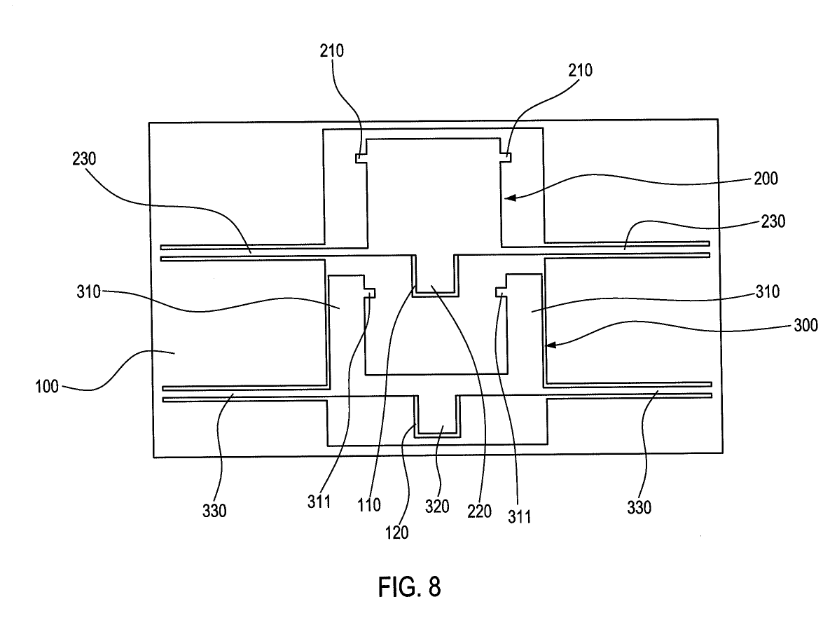

Please refer to FIGS. 7 and 8, in practice, when the oblique angle of the oblique body 200 is greater than 90°, the first push pad 220 of the oblique body 200 and the second push pad 320 of the U-shaped supporting rack 300 are formed in the same direction (as shown in FIG. 7). In addition, the lengths of two supports 310 of the U-shaped supporting rack and the positions of the second lugs are defined by the etching process, as well as the positions of the first lugs 210 on the both sides of the oblique body 200, thus the three-dimensional microstructure with various oblique angles greater than 90° may be packed to fit the optical platform applications.

For example, when the height of the oblique body 200 is equal to the length of the support 310 (as shown in FIG. 8), the microstructure of the present invention can be used to pack the three-dimensional oblique microstructure with an angle equal to 135°. As description above, when the height of the oblique body 200 is shorter than the length of the support 310, the microstructure of the present invention can be used to pack the three-dimensional oblique microstructure with an angle greater than 135°; when the layout of the height of the oblique body 200 is longer than the length of the support 310, the microstructure of the present invention can be used to pack the three-dimensional oblique microstructure with an angle smaller than 135°.

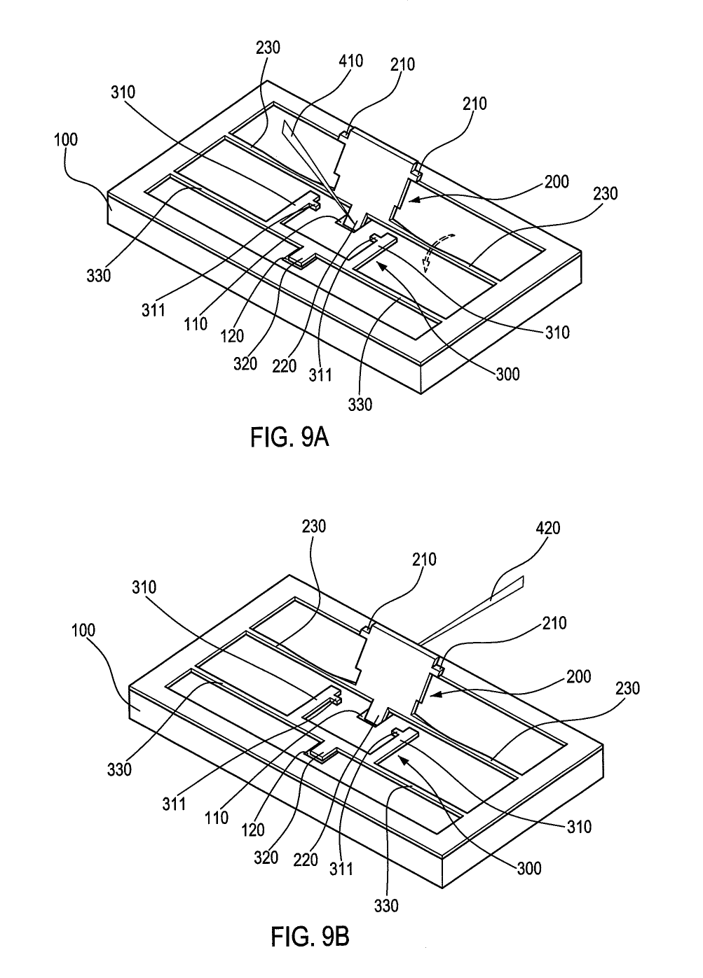

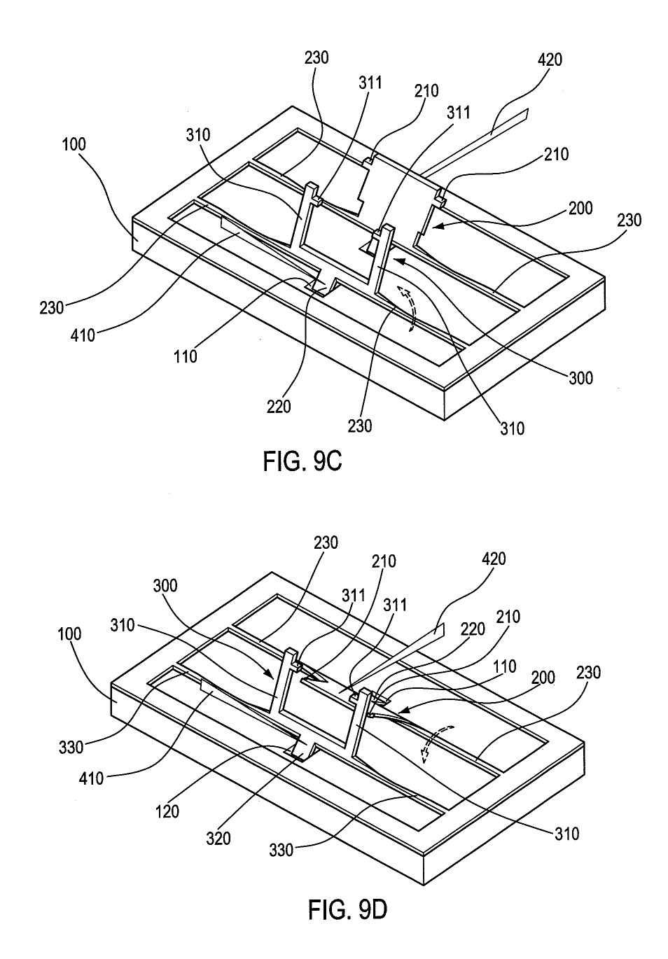

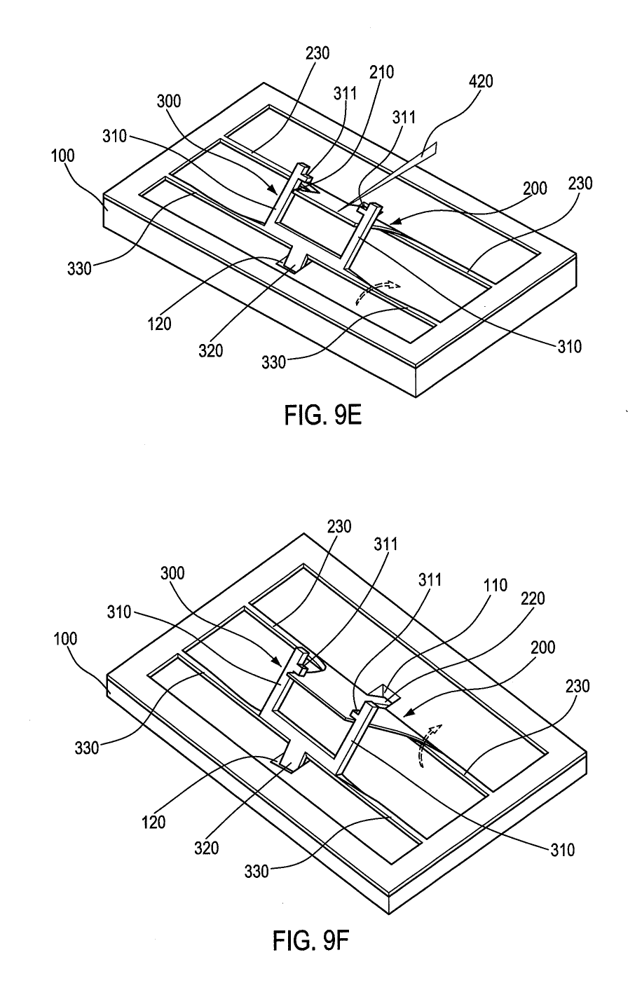

FIG. 9A to 9F are schematic diagrams illustrating the microstructure of FIG. 7 (three-dimensional oblique microstructure with an angle of 135°). The three-dimensional oblique microstructure with the angles larger than 90° are packed by the following steps: a first probe 410 is used to press down the first push pad 220 into the first accommodation space 110 to make the oblique body 200 rotate upward to an angle (not greater than 90°) (as shown in FIG. 9A) through the second twist bar 230 as an axle center; A second probe 420 is used to press against on the back of the oblique body 200 to temporarily fix the oblique body 200, such that the oblique body 200 will not move back due to the restoring force of the first twist bar 230 (as shown in FIG. 9B); Then, the first probe 410 is used again to press down the second push pad 320 into the second accommodation space 120 to make the U-shaped supporting rack rotate upward to an angle through the second twist bar 330 as an axle center (as shown in FIG. 9C); and the oblique body 200 is pushed forward through the second probe 420 to make the oblique body 200 rotate an angle more than 90° through the first twist bar 230 as an axle center (as shown in FIG. 9D); next, the first probe 410 is released, such that the two supports 310 of the U-shaped supporting rack 300 press on the sides of the first lugs 210 of the oblique body 200, respectively by the restoring force of the second twist bar 330 (as shown in FIG. 9E); finally, the second probe 420 is released, such that the oblique body 200 bounce up by the restoring force of the first twist bar 230 to lean against on the inner side of the second lug 311 of the two supports 310 (as shown in FIG. 9F); therefore, the oblique body 200 and the U-shaped supporting rack 300 can be engaged with each other by the first lugs 210 and the second lugs 311.

In practice, the first accommodation space 110 and the second accommodation space 120 may be a through hole penetrated through the substrate 100 by the photolithography etching process. The first accommodation space 110 and the second accommodation space 120 may provide an additional space for the probes in vertical direction; that is, the probes 410, 420 may be pushed in much further without affecting a final angle of the oblique body 200 and the U-shaped supporting rack 300. Besides, the position of the probe in horizontal direction does not need to be very precise as long as the probe locates within the area covered by the push pad.

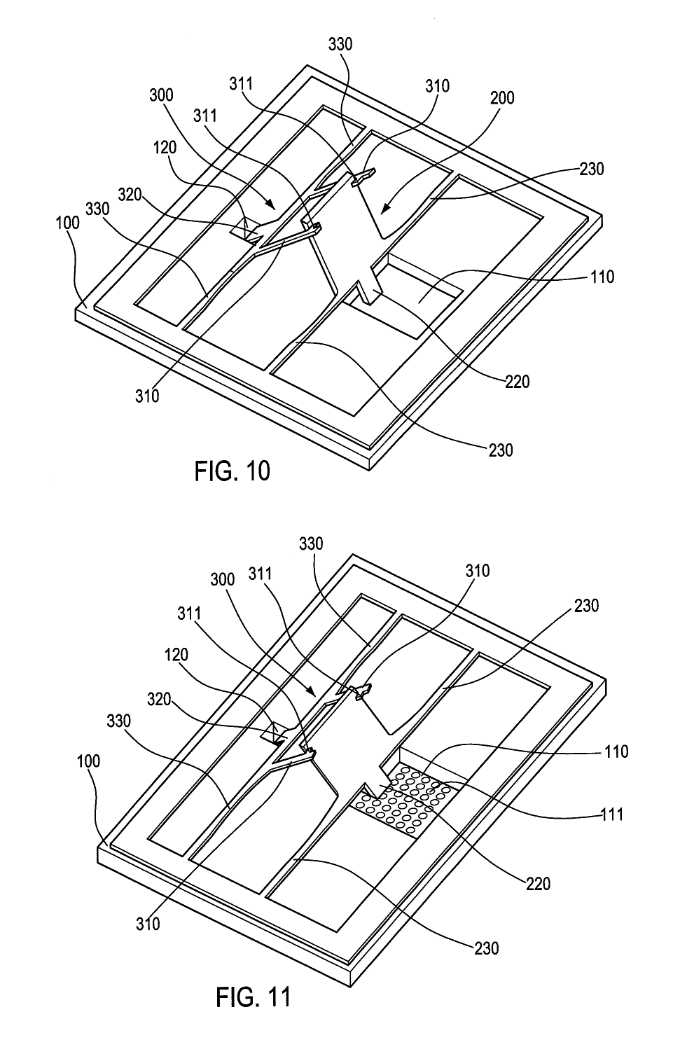

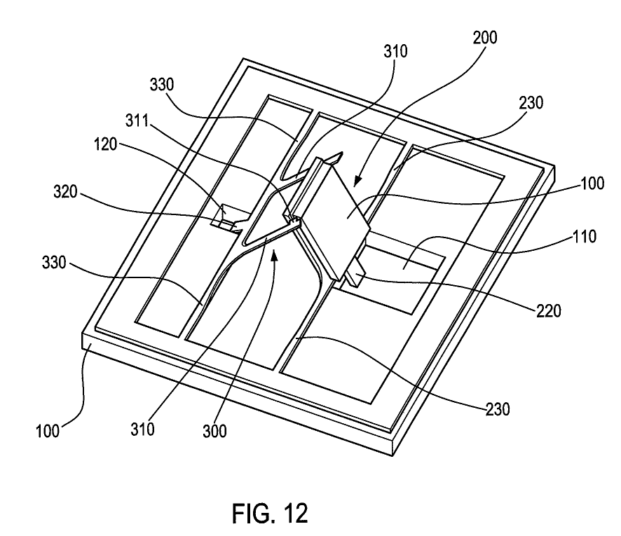

Thus, the substrate 100 under the first push pad 220 is removed by a photolithography etching process, and then the first accommodation space 110 extends to the lower part of the oblique body 200 and the surface area of the first accommodation space 110 as described above is greater than that of the oblique body 200 (as shown in FIG. 10). Or, the substrate 100 under the first push pad 220 forms a large groove on the first accommodation space 110 by an arrayed puncture 111 of which the surface area of the first accommodation space 110 is greater than that of the oblique body 200 (as shown in FIG. 11). Furthermore, the substrate 100 on the back of the oblique body 200 may be retained, so the surface area of the first accommodation space 110 is greater than that of the oblique body 200 (as shown in FIG. 12).

The description above is only for the better embodiments, and the embodiments of the present invention are not limited to the description here. That is the simple and equivalent varies and modifications within the clams and the description of the present invention are still within the scope of the claims from the present invention.

What is claimed is:

1. A three-dimensional oblique microstructure with press down and engagement mechanisms, comprising:
a substrate;
an oblique body disposed on the substrate and having a pair of corresponding first lugs respectively on both sides of the oblique body, a bottom part of the oblique body having a first push pad and a first accommodation space disposed in the substrate for receiving the first push pad, and a first twist bar extending horizontally from both sides disposed on the bottom part of the oblique body; and
an U-shaped supporting rack disposed on the substrate, a pair of corresponding second lugs respectively disposed on inner sides of two supports of the U-shaped supporting rack, a second push pad disposed on a bottom part of the U-shaped supporting rack, a second accommodation space disposed in the substrate for receiving the second push pad, and a second twist bar extending horizontally from both sides disposed on the bottom part of the U-shaped supporting rack; by pressing down the first push pad and the second push pad, the oblique body rotating to an angle through the first twist bar as an axle center and the U-shaped supporting rack rotating to an angle through the second twist bar as an axle center so as to form the three-dimensional microstructure by engaging the first lugs with the second lugs.

2. The three-dimensional microstructure of claim 1, wherein the first push pad of the oblique body and the second push pad of the U-shaped supporting rack are formed in opposite directions, and a shape of an upper part of the oblique body is matched with a shape of the bottom part of the U-shaped supporting rack.

3. The three-dimensional microstructure of claim 1, wherein the first push pad of the oblique body and the second push pad of the U-shaped supporting rack are formed in a same direction, and a shape of the first push pad of the oblique body is matched with the bottom part of the U-shaped supporting rack.

4. The three-dimensional microstructure of claim 1, wherein positions of the first lugs on the both sides of the oblique body is arranged by a predetermined oblique angle and correspond to positions of the second lugs of the U-shaped supporting rack so as to engage each other for securing the oblique body and the U-shaped supporting rack.

5. The three-dimensional microstructure of claim 1, wherein the positions of the second lugs on the inner sides of the supports of the U-shaped supporting rack is arranged by a predetermined oblique angle of the oblique body and correspond to the first lugs of the oblique body so as to engage each other for securing the oblique body and the U-shaped supporting rack.

6. The three-dimensional microstructure of claim 1, wherein surface areas of the first accommodation space and the second accommodation space are greater than areas of the first push pad and the second push pad.

7. The three-dimensional microstructure of claim 1, wherein the first accommodation space and the second accommodation space are a through hole penetrated through the substrate.

8. The three-dimensional microstructure of claim 1, wherein the first accommodation space extending to the bottom part of the oblique body and having a surface area greater than a surface area of the oblique body.

9. The three-dimensional microstructure of claim 8, wherein the first accommodation space is penetrated through the substrate.

10. The three-dimensional microstructure of claim 8, wherein the first accommodation space is penetrated through the substrate and retains the substrate on back of the oblique body.
